(19) United States
(12) Patent Application Publication
(10) Pub. No.: US 2008/0282048 A1
(43) Pub. Date: Nov. 13, 2008

(54) CONTROLLER, CONTROL SYSTEM, AND CONTROL PROGRAM

(75) Inventor: Hiroshi MIURA, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/877,152

(22) Filed: Oct. 23, 2007

(30) Foreign Application Priority Data
Dec. 13, 2006 (JP) 2006-335972

(51) Int. Cl. G06F 12/00

(52) U.S. Cl. 711/162

(57) ABSTRACT

The controller of the present invention provides a transfer rate determiner determining a transfer rate of the backup data transmitted from a plurality of apparatuses through a communication link on the basis of the achievement of transfer rates in the past, a schedule adjuster generating a schedule by editing the transfer rates of the backup data determined with the transfer rate determiner, and a backup operation backing up the backup data in accordance with the generated schedule edited with the schedule adjuster.

### CROSS-REFERENCE TO RELATED APPLICATIONS

This application is related to and claims priority to Japanese patent application No. 2006-335972 filed on Dec. 13, 2006, in the Japan Patent Office, and incorporated by reference herein.

### BACKGROUND OF THE INVENTION

1. Field of the Invention

This controller relates to a controller connected to a single apparatus or a plurality of apparatuses through a communication link for controlling data processes and particularly to a controller for receiving backup data transmitted from a plurality of apparatuses, dynamically storing the same backup data through dynamic domain-division, and transmitting the same backup data based on the request from a plurality of apparatuses. Moreover, this system also relates to a control system comprising a plurality of apparatuses and a controller and a control program for controlling the same control system.

2. Description of the Related Art

A computer that requires backup (hereinafter referred to as a backup-aided computer) has generated data disappearing situation due to a failure occurring in the same computer. Therefore, a backup apparatus executes following processes in view of avoiding such data disappearing situation.

A method with which the backup apparatus conducts backup of data to be stored in the backup-aided computer to the same backup apparatus will be explained first.

In the conventional backup system, the backup apparatus periodically receives and stores the data of the backup-aided computer. If data disappears, the backup apparatus transmits backup data of the backup-aided computer. As explained above, the backup-aided computer can recover the data by receiving the backup data from the backup apparatus.

This system proposes a system which can recover the data stored in the backup-aided computer particularly when a large scale disaster has occurred by installing a backup apparatus to the place separated far from a backup-aided computer. This system realizes, for the backup apparatus, remote backup process of important data such as bank data stored in the backup-aided computer. For the remote backup process, the backup apparatus often executes backup process by transferring data stored in the backup-aided computer through a transmission link such as WAN or the like extended between LANs. In the case where a plurality of backup-aided computers transfer data to a single backup apparatus through the communication link, frequency sharing is conducted because bandwidth of the communication link is limited. When the number of backup-aided computer increases as explained above, quantity of data for backup process tends to be increased. In general, backup process is often limited in its backup time to the time other than the business time, for example, nighttime. Therefore, the backup apparatus has to execute backup process of a large amount of data within the determined period. As a result, following problems are generated.

In the system of the related art, amount of data is increasing due to increase in the number of backup-aided computer installed. A problem generated here is how the backup apparatus should realize the backup process of a large amount of data while the data increased in the number is shared with the communication link having the allowable bandwidth.

In addition, when the backup process time is limited, for example, to the nighttime, backup process of a large amount of data will generate congestion of communication link, resulting in a problem that a longer time is required for the backup apparatus to realize the backup process.

Considering the background explained above, a method, for example, of temporarily storing backup data has been employed in order to control a load of communication link and backup apparatus and to improve performance of backup process.

For example, the “Accumulation Type Data Transfer System and Data Transfer Schedule Determination Method” described in the Publication No. 2000-270010 of the Japanese Laid-Open Patent Application as the patent document 1 describes the technology for satisfying the transfer end request time by controlling a load of communication link and backup apparatus, improving performance of backup process, and transferring data before the designated transfer end time. Moreover, a transfer schedule for data transfer is determined considering conditions of communication link or the like and moreover by re-determining the transfer schedule once determined in accordance with change in the conditions in view of always satisfying the transfer end request time.

As explained above, the prior art discloses a backup technology in which a backup apparatus determines both accumulation time and transfer start time to determine a data transfer schedule. The prior art offers a data transfer method for transferring data before transfer end request time while controlling load of the backup apparatus and load of the accumulation capacity and communication link. A transfer schedule for data transfer in the backup technology of the prior art is determined in unit of block by decomposing data into blocks of the same size with the backup apparatus. The backup apparatus transfers data on the basis of determined transfer schedule. If the backup apparatus and communication link are in the congestion state at the time of transfer, the backup apparatus temporarily stops transfer of data from the backup-aided computer. The backup apparatus restarts transfer of data decomposed into the blocks of the same size when the backup apparatus and communication link recover from the congestion state.

However, following problems are generated in the backup technology of the prior art on the occasion of transferring data. For example, quantity of data cannot be determined in some cases because it is largely influenced by progress in the process like CAD data and source code of software or the like at the time of designing a backup apparatus. In such a case, it is impossible for the backup apparatus to forecast the quantity of data to be transferred. When quantity of data to be transferred cannot be forecasted as explained above, since total quantity of data is not grasped, the backup apparatus temporarily stops transfer of data from the backup-aided computer, if the backup apparatus and communication link are in the congestion state. Accordingly, a problem is generated, in which the backup apparatus cannot realize effective data transfer and thereby data transfer cannot be completed within the preset time. If data transfer is not completed within the predetermined time, it means that the latest information of the backup-aided computer always does not exist within the backup apparatus. Therefore, the backup system becomes unstable because the latest information is no longer backed up with the backup system even if a disaster occurs suddenly.

Moreover, quantity of transfer data cannot be decomposed into the blocks of the same size in some cases. In the prior art, the backup apparatus completely fixes a transfer rate of data into the blocks of the same size. Therefore, since the backup apparatus requires a longer time to decompose the transfer rate into the blocks of the same size, it becomes difficult to generate within a short period a transfer schedule, thereby resulting in a problem that data cannot be transferred effectively.

### SUMMARY OF THE INVENTION

Considering the background explained above, the backup apparatus in the present invention forecasts a transfer rate of data inputted to the backup apparatus from the backup-aided computer. Moreover, the backup apparatus always stores the latest information by forming a schedule based upon a forecasted backup transfer rate, which will not result in the congestion state of the backup apparatus and communication link. In addition, the present invention provides a stable backup apparatus which can recover immediately the latest environment by effectively transferring data even if a disaster occurs.

Moreover, the backup apparatus of the present invention decomposes a forecasted transfer rate of the data into editable blocks. The backup apparatus edits the decomposed blocks in accordance with bandwidth state of communication link and effectively generates a schedule for backup process effectively transfers data within a short period of time.

In accordance with an aspect of the present invention, the problems explained above can be achieved by providing a controller connected to a plurality of apparatus through a communication line for controlling execution of backup process by operations comprising determining a transfer rate of backup data transmitted from a plurality of the apparatuses through the communication link on the basis of achievement of transfer rate in the past, generating an adjusted schedule by editing a transfer rate of backup data according to the transfer rate determining, and backing up data in accordance with the schedule edited and generated by the schedule adjusting.

Moreover, the present invention provides a data storage storing the schedule of backup process edited and generated by the schedule adjusting.

Moreover, the transfer rate determining determines a transfer rate of the backup data for backup process from an average transfer rate of the backup data during a constant period in the past having completed the backing up process.

Moreover, the transfer rate determining provides determining a transfer rate of the backup data for backup process from a transfer rate varying pattern of backup data during a constant period in the past having completed the backing up process.

Moreover, the transfer rate determining provides obtaining a transfer rate of the backup data for backup process from history information of backup data having completed the backing up process.

Moreover, the schedule adjusting provides domain-dividing, in a constant interval, a transfer rate of the backup data for backup process included in the schedule determined with the transfer rate determining and conducts edition with a transfer rate of the domain-divided backup data defined as one control unit.

Moreover, the schedule adjusting provides editing a transfer rate to accommodate the same transfer rate of the backup data within the schedule for the backing up process.

Moreover, the present invention provides when the backup data domain-divided in one control unit exists in the domain outside of range of the schedule, the schedule adjusting adjusts bandwidth of the backup data which is same in the kind as the backup data domain-divided in the relevant one control unit in the domain outside of range of the schedule and is existing in the domain within the range of the schedule.

Moreover, the present invention provides when any backup data, domain-divided in one control unit, exists in the domain outside of range of the schedule after adjustment of bandwidth of the backup data, the schedule adjusting adjusts bandwidth of backup data existing within the range of the schedule and permitting adjustment of bandwidth.

Moreover, the schedule adjusting deletes, if an adequate backup data does not exist, a part of the backup data existing within the range of the schedule.

Moreover, the present invention stores past transfer rate achievement data (a log) by storing a log of a completed backing up process for the backup data.

Moreover, the transfer rate determining determines, after the transfer achievement storing has stored a log of the backup data, a transfer rate of the backup data transmitted through a communication link from a plurality of the apparatuses on the basis of the transfer rate of the backup data.

Moreover, the control system of the present invention comprising a plurality of apparatuses and a controller connected with a plurality of the apparatuses through a communication link for controlling execution of backup data is characterized in that a plurality of apparatuses respectively include a transmitter transmitting the backup data to the controller, and the controller further comprises a transfer rate determiner determining a transfer rate of backup data transmitted from a plurality of apparatuses through the communication link on the basis of achievement of transfer rate in the past, a schedule adjuster generating or editing a transfer rate of backup data in the schedule determined with the transfer rate determining, and a backup process (operation) backing up the backup data in accordance with information generated or edited with the schedule adjuster.

Moreover, the present invention provides storing a schedule of backup process generated or edited with the schedule adjuster.

Moreover, the transfer rate determiner determines a transfer rate of the backup data for backup process from an average transfer rate of backup data during a constant period in the past having completed the backing up process.

Moreover, the transfer rate determiner determines a transfer rate of the backup data for backup process from a transfer rate varying pattern of backup data during a constant period in the past having completed the backup process.

Moreover, the transfer rate determiner obtains a transfer rate of backup data in the schedule from history information storing the backup data having completed the backup process.

Moreover, the control system comprising a plurality of apparatuses and a controller connected with a plurality of the apparatuses through a communication link for controlling execution of backup data is characterized in that a plurality of the apparatuses respectively comprise a transmitter transmitting the backup data to the controller, and the controller comprises a transfer rate determiner determining a transfer rate of backup data transmitted from a plurality of the apparatuses through the communication link on the basis of achievement of transfer rate in the past, a schedule adjuster generating a schedule by domain-dividing, in a constant interval, a transfer rate of backup data determined with the transfer rate determining and by conducting edition with the transfer rate of the domain-divided backup data defined as one control unit, and a backup process (operation) conducting backup process of the backup data in accordance with the schedule edited and generated with the schedule adjuster.

Moreover, the schedule adjuster executes edition of the relevant transfer rate in order to accommodate the transfer rate of the backup data within the schedule for backup process.

Moreover, the present invention provides in that when said backup data, domain-divided in one control unit, exists in the domain outside of range of the schedule, the schedule adjuster adjusts bandwidth of backup data which is same in kind to the backup data, which has been domain-divided in one control unit and existing in the domain outside of range of the schedule and exists within the range of the schedule.

The present invention provides in that when any backup data, domain-divided in one control unit, exists in the domain outside of range of the schedule after adjustment of bandwidth of the backup data, the schedule adjuster adjusts bandwidth of backup data existing within the range of the schedule and permitting adjustment of bandwidth.

Moreover, the schedule adjuster provides in deleting, if an adequate backup data does not exist, a part of the backup data existing within the range of the schedule.

Moreover, the backup process stores, after backup process of the backup data, the relevant backup data into an information table as history information.

Moreover, the present invention stores past transfer rate achievement data (log) by storing a log of a completed backup process for the backup data.

Moreover, the transfer rate determiner determines a transfer rate of backup data transmitted from a plurality of the apparatuses through the communication link on the basis of transfer data of the relevant backup data after the transfer achievement storing.

Moreover, the backup program executed with a computer connected with a plurality of apparatuses through a communication link for backup process provides in controlling the computer to execute the operations of determining a transfer rate of backup data transmitted from a plurality of the apparatuses through the communication link on the basis of achievement of transfer rate in the past, generating a schedule by editing the determined transfer rate of backup data, and executing backup process of the backup data in accordance with the generated and edited schedule.

Moreover, the present invention provides storing a backup process schedule generated by editing the determined transfer rate of backup data.

Moreover, the backup program provides obtaining a log of the backup process and storing the backup process log.

Moreover, a backup method executed with a computer connected with a plurality of apparatuses through a communication link for backup process provides determining a transfer rate of backup data transmitted from a plurality of the apparatuses through the communication link on the basis of achievement of transfer rate in the past, generating or editing the determined transfer rate of backup data, and executing backup process of the backup data in accordance with information stored in the schedule after generation or edition.

Moreover, the backup method provides storing a schedule for backup process generated by editing the determined transfer rate of backup data.

The backup method provides storing a log of the backup data used for backup process.

This system can provide the following effects.

This controller, control system and control program is capable of forecasting a transfer rate of data for backup process. The forecasted transfer rate of data is determined on the basis of the average transfer rate of backup data during a constant period in the past having completed the backup process or the transfer rate varying pattern. The controller of the present invention executes scheduling on the basis of the forecasted transfer rate of data to set the controller and communication link to the congestion state in order to always store the latest information. Accordingly, it is possible to provide the stable controller, control system and control program which always assure the latest information existing in the backup apparatus in the stable state and thereby can immediately recover the latest environment even if a computer readable media related error occurs.

Moreover, the controller, control system and control program are decomposing the forecasted transfer rate of data into editable blocks. The backup apparatus edits the decomposed blocks in accordance with state of bandwidth of the communication link and generates an effective schedule for the backup process. Thereby, the controller is capable of executing the backup process in accordance with the generated schedule. Namely, this controller conducts scheduling by effectively using the time in order to receive within a short period of time the data of backup-aided computer. Therefore, since scheduling has been executed in the present invention by effectively using the time in comparison with the prior art, it is possible to provide the controller, control system, and control program for effectively transferring the data for backup process effectively within the short period of time.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 illustrates total structural diagram of a backup system based on an embodiment of the present invention.

FIG. 2 illustrates schematic system structural diagram of an online network of the backup system.

FIG. 3 illustrates graph for computing an average transfer rate of data to be backup-processed as the first example.

FIG. 4 shows flowchart for computing the average transfer rate of data to be backup-processed.

FIG. 5 illustrates graph for computing the average transfer rate of data to be backup-processed as the second example.

FIG. 6 illustrates table A of the graph for computing the average transfer rate of data to be backup-processed and data format diagram of a backup log.

FIG. 7 shows flowchart of the graph for computing the average transfer rate of data to be backup-processed.

FIG. 8 illustrates diagram showing a schedule information table.

FIG. 9 illustrates diagram showing relationship between time and allowable bandwidth regarding a data transfer rate of the backup process.

FIG. 10 illustrates determination diagram for compliance with restriction.

FIG. 11 illustrates explanatory diagram of an adjusting method when violence of restriction in the direction of time T occurs in the time zone T(T[0] to T[n]).

FIG. 12 illustrates explanatory diagram of the adjusting method when a restriction in the direction of allowable bandwidth R is violated in the allowable bandwidth R for data transfer.

FIG. 13 shows flowchart of the determining method for compliance with restriction.

FIG. 14 shows diagram continued from FIG. 13.

FIG. 15 shows detail flowchart for generation of restriction determining diagram.

FIG. 16 illustrates detail table for generation of restriction determining diagram.

FIG. 17 illustrates detail flowchart for check of restricting conditions.

FIG. 18 illustrates detail table A and schedule data B for check of restricting conditions.

FIG. 19 illustrates flowchart showing detail method for reducing by one unit the bandwidth of job satisfying the conditions in the restriction determining diagram.

FIG. 20 shows processing flowchart of backup processing program in backup apparatus.

FIG. 21 shows processing flowchart of the transfer achievement storing program in the backup apparatus.

### DETAILED DESCRIPTION OF THE PREFERRED EMBODIMENTS

A preferred embodiment of this system will be explained with reference to the accompanying drawings. A structure of the following embodiment is only an example and this system is not limited only to this embodiment.

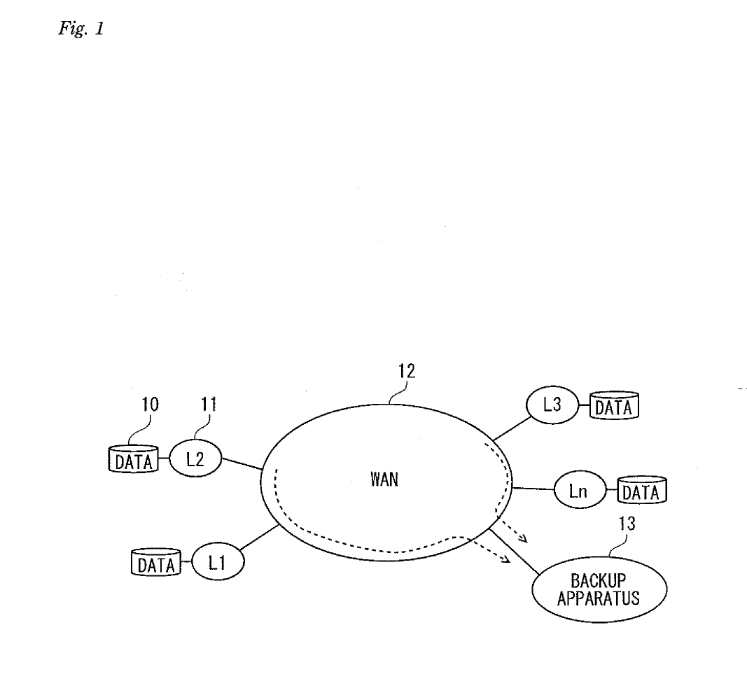

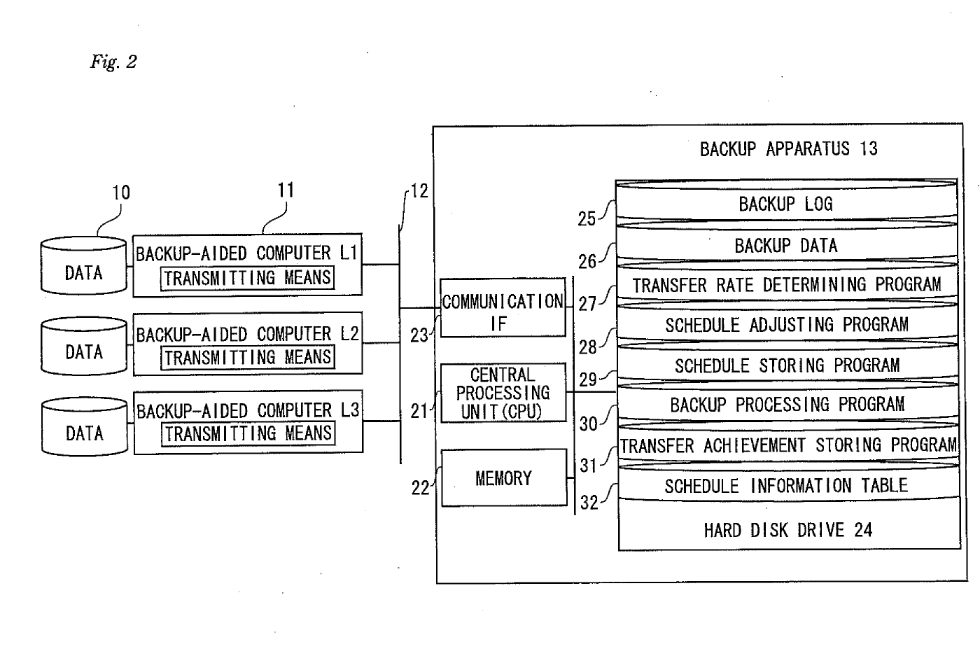

An example of a schematic structure of a backup system related to this embodiment will be explained with reference to FIG. 1 and FIG. 2.

FIG. 1 is a total structural diagram of a backup system of this embodiment. This backup system comprises backup-aided computers (L1 to Ln10) 11, data 10 stored in the backup-aided computers 11 and a backup apparatus 13 for transmitting and receiving data 10 to and from the backup-aided computers 11 through a network WAN. As will be explained with reference to FIG. 2, the backup apparatus 13 comprises a central processing unit (CPU) 21, a memory 22 connected to CPU 21, a communication interface (IF) 23 connected to CPU 21, and a hard disk drive 24 connected to CPU 21. Moreover, the hard disk drive 24 stores therein backup log 25, backup data 26, transfer rate determining program 27, schedule adjusting program 28, schedule storing program 29, backup processing program 30, transfer achievement storing program 31, and schedule information table 32.

The data 10 stored in the backup-aided computers (L1 to Ln10) 11 is transferred to the backup apparatus 13 through WAN 12.

In this embodiment, as the backup apparatus 13, a magnetic tape library that has been used widely may be used. However, other storage device such as optical disk storage and magneto-optical storage device can also be used in the present invention. Otherwise, these storage devices may also be used in combination. Moreover, a magnetic tape may also be used as a storage medium. However, it is preferable to connect a large capacity storage device for storing the backup data.

In addition, the data 10 stored in a database is considered as the object data for backup (hereinafter referred to as backup-aided data) in this embodiment. However, this system is never limited thereto and the data stored in a file may also be considered as the backup-aided data.

Here, only a unit of backup apparatus 13 is provided as shown in the figure in this embodiment, but a plurality of apparatuses may also be provided. Moreover, the backup apparatus 13 controls the backup processes to determine a schedule of the backup processes in the system as a whole. However, it is also permitted that the backup-aided computer 11 respectively determines a schedule for backup process and the backup apparatus 13 execute the backup process in accordance with such schedule information.

FIG. 2 shows an example of a schematic system structural diagram of an online network of the backup system of this embodiment.

The backup system related to this embodiment comprises data 10 stored in the backup-aided computer 11, a backup-aided computer 11 and a backup apparatus 13 for transmitting and receiving data 10 to and from the backup-aided computer 11 through a network WAN 12.

The backup apparatus 13 of the present invention comprises a central processing unit (CPU) 21, a memory 22 connected to CPU 21, a communication interface 23 connected to CPU 21, and a hard disk drive 24 connected to CPU 21.

The hard disk drive 24 in the backup apparatus 12 stores backup log 25, backup data 26, transfer rate determining program 27, schedule adjusting program 28, schedule storing program 29, backup process program 30, transfer rate achievement storing program 31, and schedule information table 32.

In this embodiment, the hard disk drive 24 in the backup apparatus 13 stores information. However, such information may also be stored using a large capacity storage device connected to the backup apparatus for storing the data 10 having completed the backup process.

Function of each structure in the backup apparatus 13 will be explained hereinafter. CPU 21 receives the data 10 from the backup-aided computer 11. CPU 21 once stores the received data 10 to the memory 22. For the backup process of data 10 stored in the memory, CPU 21 executes a program stored in the hard disk drive 24. The memory 22 temporarily stores data when CPU 21 processes data 10. The communication interface 23 executes communication of data 10 between the backup-aided computer 11 and CPU 21 in the backup apparatus 13 through the network WAN 12.

As explained above, when a backup process request for the data 10 is issued to the backup apparatus 13 from the backup-aided computer 11 in such backup system, CPU 21 in the backup apparatus 13 makes access to the hard disk drive 24. Next, CPU 21 executes following programs stored in the hard disk drive 24. Namely, the transfer rate determining program 27, backup processing program 30 and transfer rate achievement storing program 31 are sequentially executed for backup process of data 10.

Various programs on the hard disk drive 24 in the backup apparatus 13 will be explained.

The transfer rate determining program 27 is stored in the hard disk drive 24 of the backup apparatus 13. This program is read as required into the memory 22 and is executed with CPU 21. The transfer rate determining program 27 functions as a transfer rate determiner determining a transfer rate of data 10 for backup process on the basis of the transfer rate achievement in the past.

The schedule adjusting program 28 is stored in the hard disk drive 24 of the backup apparatus 13, read as required into the memory 22 and is executed with CPU 21. Moreover, the schedule adjusting program 28 functions as a schedule adjuster adjusting a schedule for the backup process on the basis of the information having determined a transfer rate of data 10 for backup.

The schedule storing program 29 is stored in the hard disk drive 24 of the backup apparatus 13, read as required into the memory 22 and is executed with CPU 21. Moreover, the schedule storing program 29 stores the schedule for the backup process generated or edited with the schedule adjusting program 28.

The backup processing program 30 is stored in the hard disk drive 24 of the backup apparatus 13, read as required into the memory 22 and is executed with CPU 21. Moreover, the backup processing program 30 functions as a backup operation executing the backup process of the schedule-adjusted data 10. The backup processing program 30 stores the backup-processed data 10 in the hard disk drive 24 as the backup data 26.

The transfer achievement storing program 31 is stored in the hard disk drive 24 of the backup apparatus 13, read as required into the memory 22 and is executed with CPU 21. Moreover, the transfer achievement storing program 31 functions as a transfer achievement storing means for storage operation storing a log of the achieved transfer rate of data 10 having completed the backup process with the backup processing program 30. The transfer achievement storing program 31 stores the transfer achievement of data 10 in the hard disk drive 24 as the backup log 25. The processing operations of the backup system will be explained below.

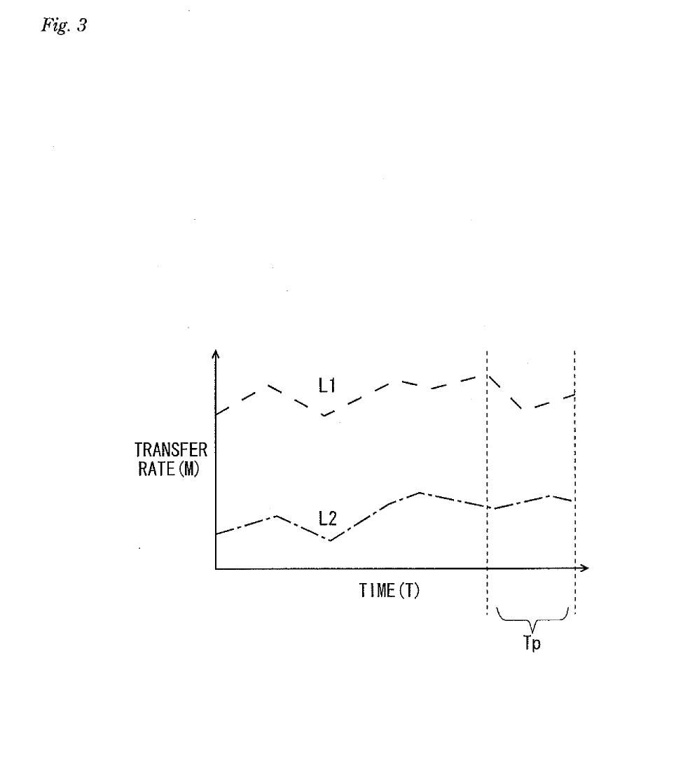

CPU 21 in the backup apparatus 13 of the present invention receives the data 10 to be stored in the backup-aided computer 11 through the network WAN 12. CPU 21 executes the transfer rate determining program 27 on the hard disk drive 24. This transfer rate determining program 27 determines a transfer rate of the received data 10 on the basis of the transfer rate achievement in the past. Here, achievement of transfer rate in the past can be obtained using the backup log 25 stored in the hard disk drive 24. The backup apparatus 13 in the present invention generates a schedule not to result in congestion state of the backup apparatus 13 and WAN 12 on the basis of the forecasted transfer rate of data 10. Detail processing operations of the transfer rate determining program 27 will be explained later with reference to FIG. 3 to FIG. 7.

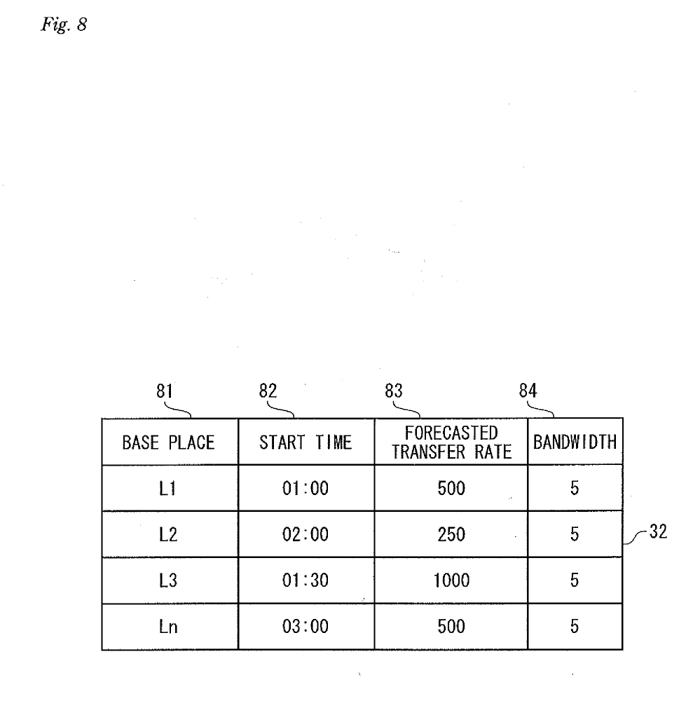

The schedule adjusting program 28 generates or edits the transfer rate of data 10 determined with the transfer rate determining program 27 in order to set the same transfer rate within the range of the schedule for the backup process. Detail processing operations of the schedule adjusting program 28 will be explained later with reference to FIG. 8 to FIG. 19.

The schedule storing program 29 stores the schedule for the backup process generated or edited with the schedule adjusting program 28.

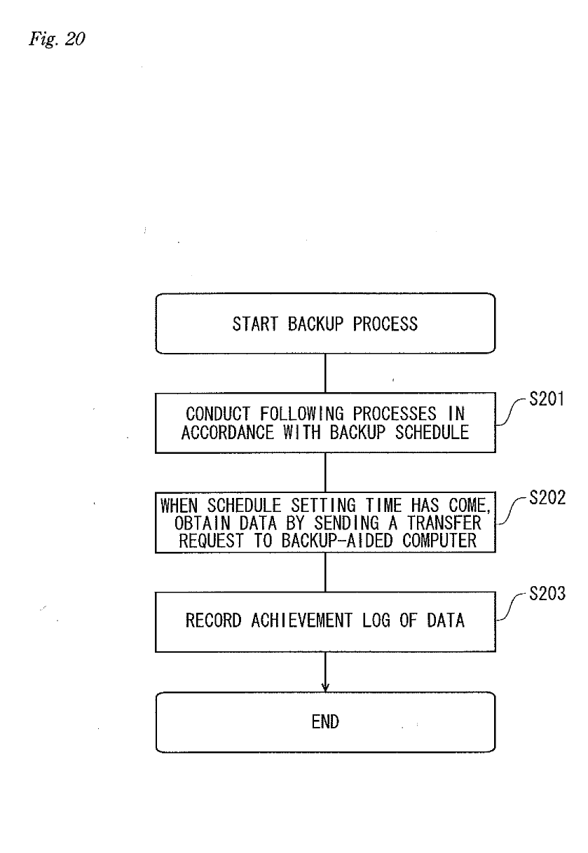

The backup processing program 30 executes the backup process of data 10 in accordance with the schedule which has been generated or edited with the schedule adjusting program 28 and is stored with the schedule storing program 29. The backup processing program 30 stores the data 10 having completed the backup process on the hard disk drive 24 in the backup apparatus 13 as the backup data 26. Detail processing operations of the backup processing program 30 will be explained with reference to FIG. 20.

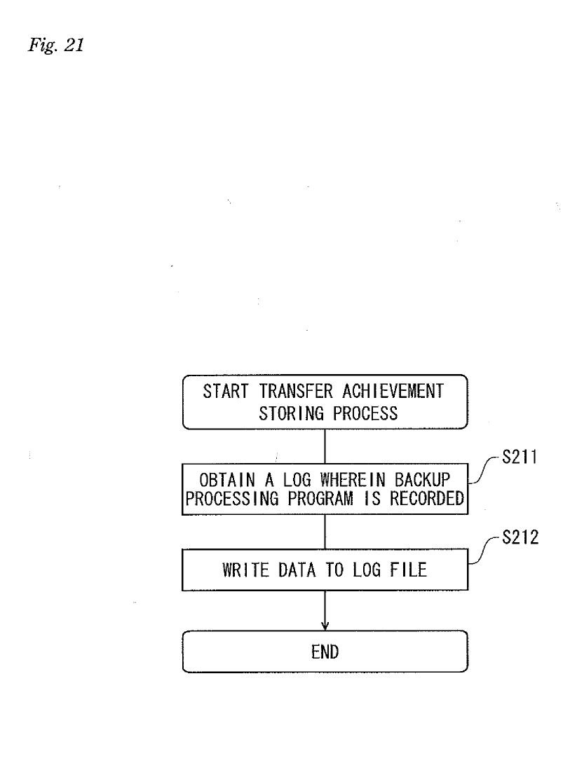

The transfer achievement storing program 31 stores a log of the data 10 having completed the backup process with the backup processing program 30 on the hard disk drive 24 in the backup apparatus 13. The transfer achievement of data 10 is stored in the hard disk drive 24 as the backup log 25 as the information about the achieved transfer rate of the data 10 during the backing up process. Detail processing operations of the transfer rate achievement storing program 31 will be explained with reference to FIG. 21. As explained above, the backup apparatus 13 executes the backup process of the data 10 of the backup-aided computer 11 by sequentially operating the transfer rate determining program 27, schedule adjusting program 28, schedule storing program 29, backup processing program 30 and transfer rate achievement storing program 31.

Next, how to obtain an average transfer rate of the data 10 for the backup process with the backup apparatus 13 in the backup system of the present invention will be explained below. A method for obtaining the average transfer rate will be explained below with reference to FIG. 3 to FIG. 7.

FIG. 3 is a graph for explaining computation to obtain the average transfer rate of data 10 to be subjected to the backup process of the backup apparatus 13. The backup log 25 stored in the hard disk drive 24 in the backup apparatus 13 is recording changes in the transfer rate of the data 10 transmitted through the network WAN 12.

The vertical axis of graph indicates a transfer rate (M) and the horizontal axis indicates a time (T), plotting transition of transfer rates of the data 10 for backup process. In general, in the case of transmitting the data 10 to the backup apparatus 13 from the backup-aided computer 11, a transfer rate of the data 10 tends to become constant. When attention is paid to this property, it can be understood that the backup apparatus 13 stores transfer rate achievement of the data 10 to be subjected to the backup process. The transfer rate determining program 27 in the backup apparatus 13 obtains an average transfer rate of the data 10 of the constant period in the past indicated as Tp in FIG. 3. In FIG. 3, transfer rates of the data 10 for conducting the backup process of the backup-aided computers L1 and L2 are plotted. The transfer rate determining program 27 obtains an average value of the transfer rates of the data 10 respectively from the backup-aided computers L1 and L2 and the relevant average value obtained is defined as a transfer rate (Ta) of the data 10 to be backup-processed later.

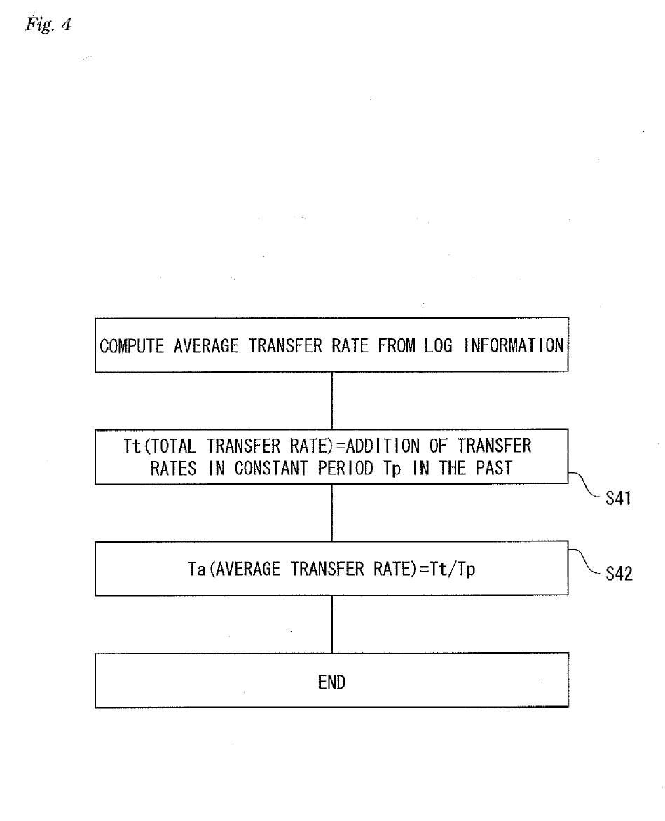

FIG. 4 is a flowchart of the processes for computing an average transfer rate of the data 10 to be backup-processed from the backup log 25 with the transfer rate determining program 27 when the transfer rates shown in FIG. 3 can be obtained.

How to obtain an average transfer rate of the data 10 will be explained on the basis of the flowchart of FIG. 4.

The transfer rate determining program 27 of the backup apparatus 13 obtains a total transfer rate Tt of the data. Therefore, the transfer rate determining program 27 adds, by paying attention, for example, to the constant period in the past like Tp in FIG. 3 explained above, the total transfer rate of the data 10 having completed the backup process in the period Tp stored in the backup log 25 (operation S41).

Next, an average transfer rate Ta in the period Tp can be obtained by dividing all transfer rates of the data 10 for past backup processes added in the operation S41, namely the total transfer rate Tt, with the constant period Tp (operation S42).

With the processes explained above, the transfer rate determining program 27 determines an average transfer rate Ta of the data 10 to be subjected to the backup process.

When the transfer rate determining program 27 in the backup apparatus 13 determines the average transfer rate as explained above, a schedule of backup process can be generated on the basis of the determined average transfer rate. The backup apparatus 13 conducts the backup process of the data 10 stored in the backup-aided computer 11 in accordance with the schedule of backup process. Therefore, the backup apparatus 13 generates a schedule not to generate congestion state of WAN 12 in view of always storing the latest information of data 10. The backup system of the present invention can attain the stable state wherein the latest information always exists within the backup apparatus 13 and thereby can immediately recover the latest environment immediately after occurrence of a disaster.

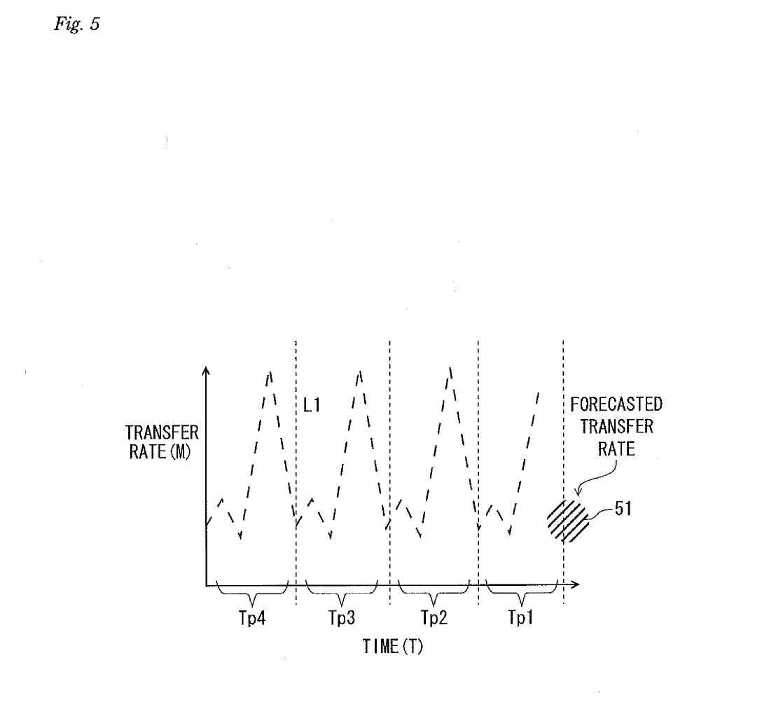

FIG. 5 is another example of an explanatory diagram for computing an average transfer rate of the data 10 to be subjected to the backup process.

The backup log stored in the hard disk drive 24 within the backup apparatus 13 stores changes in the transfer rates of the data 10 transmitted from the backup-aided computer 11 through WAN 12.

The vertical axis of the graph indicates a transfer rate (M) and the horizontal axis indicates a time (T), plotting transition of the transfer rates of data 1. In the examples of FIG. 3 and FIG. 4, a transfer rate is forecasted from the average transfer rate during the constant period Tp, but the transfer rate determining program 27 forecasts the next transfer from a variation pattern of transfer rates in the past in an example of FIG. 5. Here, attention is paid to the constant periods Tp1, Tp2, Tp3, and Tp4 in the past partitioned with an equal interval in the time (T) of the horizontal axis shown in FIG. 5. In the constant periods Tp1, Tp2, Tp3, and Tp4, a transfer rate (M) of the backup-aided computer L1 changes by repeating the constant pattern. The transfer rate determining program 27 forecasts an assumed transfer rate (hatched area 51) in the constant period Tp1 in this case on the basis of the repeated pattern of the transfer rates (M).

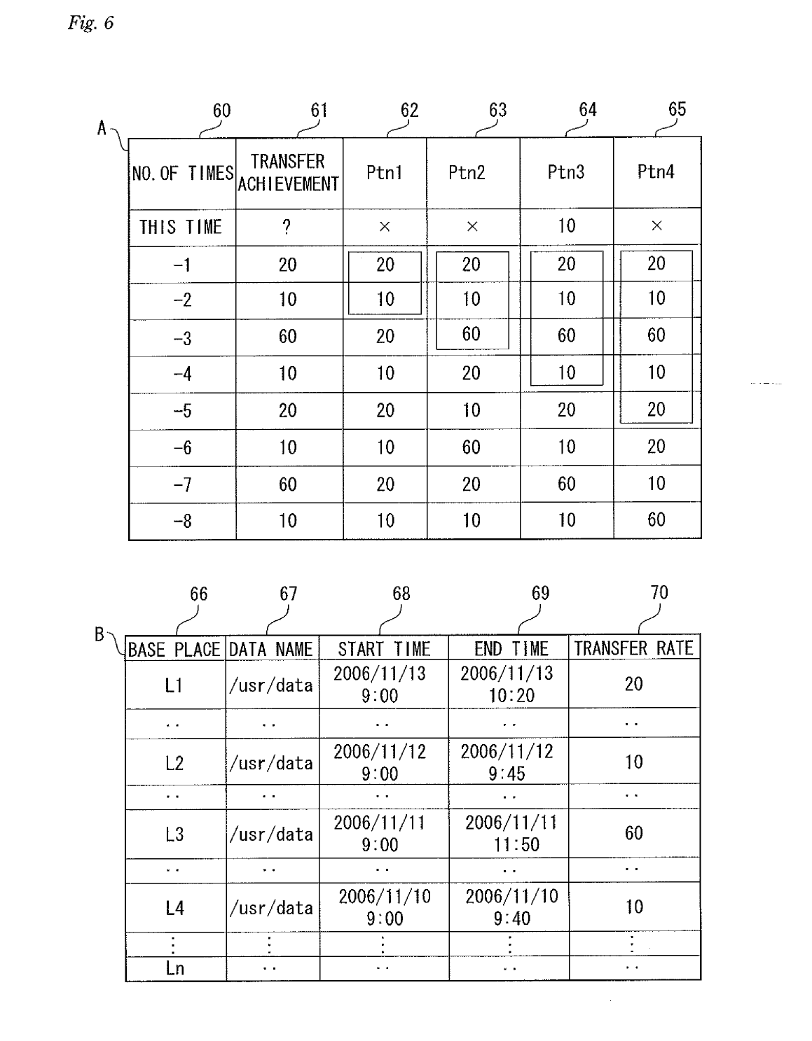

FIG. 6A is an explanatory diagram showing a graph in the shape of a table in order to compute an average transfer rate of the data 10 to be backup-processed shown in FIG. 5. Moreover, FIG. 6B shows the backup log 25 showing achievement of transfer rates in the past.

The vertical axis of the table in FIG. 6A indicates the number of counts 60, while the horizontal axis indicates the number of patterns (Ptn) 62 to 65. A method of determining transfer rates of the data 10 executed with the transfer rate determining program 27 will be explained hereunder. In the graph of FIG. 5, the transfer rate determining program 27 divides the time on the horizontal axis with a constant equal interval. The transfer rate determining program 27 reads a point where transfer rates (M) change to a large extent during the divided constant period. Moreover, this transfer rate determining program 27 also reads regularity of the transfer rates (M) from changes thereof obtained. Next, the transfer rate determining program 27 compares next the transfer achievement 61 in this case with the transfer achievements Ptn1 (62) to Ptn4 (65) in the past, forecasts a transfer rate (M) in this case from the regularity thereof, and determines, when matching is attained, the forecasted transfer rate as the transfer rate in this case.

A method of determining a transfer rate (M) in this case with the transfer rate determining program 27 will be explained below in detail with reference to FIG. 6. The transfer rate determining program 27 reads a point where the transfer rates (M) change to a large extent. The transfer rate determining program 27 judges as follows the regularity of the transfer rates (M).

The table of FIG. 6A shows examples of changing patterns of the transfer rates in the past. A pattern 1 (Ptn 1) shows repetition of the transfer rates (M) such as 20, 10, 20, 10, 20, 10, . . . . In the case of this pattern 1 (Ptn1), the transfer rate determining program 27 finds out the regularity of 20 and 10 by going back to two times in the past.

The pattern 2 (Ptn2) shows that the transfer rates (M) repeat such as 20, 10, 60, 20, 10, 60, 20, 10 . . . .

In the case of the pattern 2 (Ptn2), the transfer rate determining program 27 finds out the regularity of 20, 10, 60 by going back to three times in the past.

The pattern 3 (Ptn3) shows that the transfer rates (M) repeat such as 20, 10, 60, 10, 20, 10, 60, 10 . . . . In the case of the pattern 3 (Ptn3), the transfer rate determining program 27 finds out regularity of 20, 10, 60, 10 by going back to four times in the past.

The pattern 4 (Ptn4) shows that the transfer rates (M) repeat such as 20, 10, 60, 10, 20, 20, 10, 60 . . . . In the case of the pattern 4 (Ptn4), the transfer rate determining program 27 finds out regularity of 20, 10, 60, 10, 20 by going back to five times in the past.

The transfer rate determining program 27 searches the pattern assuring the best matching by applying the forecasted transfer rate of this case to the transfer achievement. After searching of the matching pattern, the transfer rate determining program 27 determines the forecasted transfer rate of this case from regularity. In an example of the table A, since the transfer rate achievement corresponds to the pattern 3 (Ptn3), the transfer rate in this case can be forecasted as 10 (M) from regularity of 20, 10, 60, 10 of the pattern 3 (Ptn3).

FIG. 6B explains data formats in the backup log 25.

The backup log 25 of FIG. 6B stores a base place 66 where the backup-aided computer 11 is installed, a name 67 of the data 10 to be backup-processed stored in the backup-aided computer 11, a start time 68 of the backup process for the data 10 with the backup apparatus 13, an end time 69 for completing the backup process of the data 10 with the backup apparatus 13, and a transfer rate 70 of the data backup-processed with the backup apparatus 13.

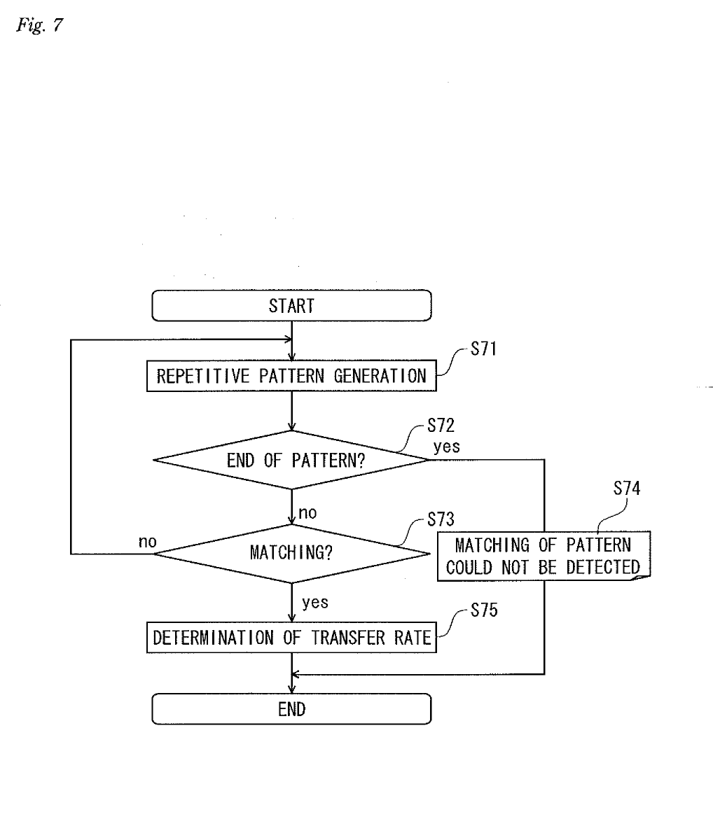

FIG. 7 is a flowchart showing the sequence of the backup process with the transfer rate determining program 27, namely determination of the forecasted transfer rate of the data 10 in this case. The transfer rate determining program 27 stored in the hard disk drive 24 in the backup apparatus 13 conducts computation for determining a transfer rate of the data 10 for backup process by referring to the backup log 25 explained above.

How to obtain a transfer rate of the data will be explained below on the basis of the flowchart. The transfer rate determining program 27 makes reference to the backup log 25. This backup log 25 stores information of the data 10 in the past having completed the backup process through the backup process of the data 10 in the backup-aided computer 11.

Moreover, the transfer rate determining program 27 reads, from a traffic data of WAN 12, a point where the transfer rate changes to a large extent to generate first a repetition pattern in the table A of FIG. 6 in view of determining the transfer rate of the data 10 to be backup-processed (operation S71).

The transfer rate determining program 27 finds out regularity from changes in the transfer rates obtained (operation S72).

The transfer rate determining program 27 searches a pattern assuring the best matching by applying the transfer achievement in this case to various pattern information pieces 62 to 65 of FIG. 6A (operation S72).

Moreover, the transfer rate determining program 27 continues searches until matching can be obtained in the pattern. If matching of pattern cannot be obtained as a result of searches, the processing operation returns again to the operation S71 in order to generate a repetitive pattern other than various pattern information pieces 62 to 65.

Moreover, when matching of pattern can be attained in the operation S73, the transfer rate determining program 27 forecasts determines a transfer rate in this case from the matched pattern (operation S75).

The pattern matched with the transfer pattern in this case cannot be detected in a certain case, in the operation S72, even if search is conducted to detect the pattern assuring the best matching from various patterns generated after the transfer rate determining program 27 has completed generation of patterns. In this case, the transfer rate determining program 27 completes forecasting of the transfer rate of this case (operation S74).

The transfer rate determining program 27 in the backup apparatus 13 determines, as explained above, the transfer rate of this time on the basis of the transfer rate varying pattern in the past. Upon determination of the transfer rate, the backup apparatus 13 can effectively generate a schedule of backup process. The backup apparatus 13 executes the backup process of the data stored in the backup-aided computer 11 in accordance with the schedule generated above. Namely, the backup apparatus 13 generates the schedule not to generate congesting state of WAN 12 and always stores the latest information of the data 10. The backup system of the present invention always maintains the latest information in the stable state in the backup apparatus 13 and thereby it can immediately recover the latest environment even after a disaster occurs.

Therefore, when the transfer rate determining program 27 determines a transfer rate of the backup process, the schedule adjusting program 28 effectively generates next a schedule of the backup process on the basis of the determined transfer rate.

Next, a method with which the schedule adjusting program 28 generates a schedule for the backup process will be explained.

FIG. 8 is a schedule information table 32 stored in the hard disk drive 24 that are referred for execution of the schedule adjusting program 28. This schedule information table 32 registers a base place 81, a start time 82, a forecasted transfer rate 83, and bandwidth 84.

The base place 81 indicates a kind of the backup-aided computers (L1 to Ln). The start time 82 indicates a start time of the backup process with the backup apparatus 13 of the data 10 stored in the backup-aided computer 11 as the base place. The forecasted transfer rate 83 is a transfer rate at each base place determined with reference to the backup log 25 in the past with the transfer rate determining program 27. The bandwidth 84 is a bandwidth used at each base place.

Any of the base place 81, start time 82, forecasted transfer rate 83 and bandwidth 84 is not required to be arranged in the sequence from the lower number and moreover the backup process is not required to be sequentially executed from the beginning of arrangement of the numbers.

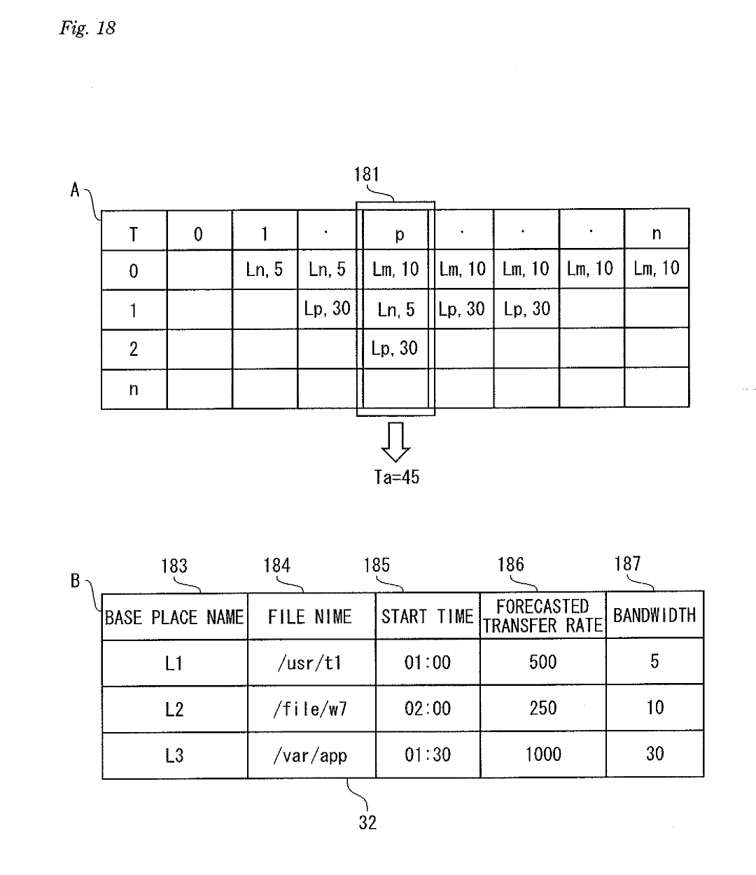

The schedule adjusting program 28 generates a schedule on the basis of a transfer rate of the data 10 determined with the transfer rate determining program 27. The schedule adjusting program 28 is capable of editing the generated schedule. Next, the schedule storing program 29 executes the process for storing the generated schedule. The backup processing program 30 executes the backup process on the basis of the schedule. Details of the schedule generated will be explained later with reference to FIG. 18.

This embodiment explains the remote backup process to be conducted with the backup apparatus 13 to realize the backup process of the important data 10 such as the bank data stored in the backup-aided computer 11 to the place separated far from the backup-aided computer 11. In this case, the backup apparatus 13 transfers the data 10 in the backup-aided computer 11 for the backup process through the communication link such as WAN 12 or the like.

A data transmission rate of WAN 12 at present is generally slower than the data transmission rate of LAN. However, here rises a problem that communication cost is not required in LAN but communication cost is required in WAN 12. In order to eliminate transmission delay in WAN 12, it is requested to use a link as higher as possible in the transmission rate. Meanwhile, the higher the transmission rate is, the higher the communication cost of link becomes. Therefore, it is impossible from the economical reason to use the communication link which assures only extensively higher transmission rate.

Accordingly, in the case of implementing the backup process of the data 10 stored in the backup-aided computer 11 through WAN 12, the time T enabling the backup and the allowable bandwidth R for transferring the data are restricted. Moreover, in some cases, the backup start time is restricted due to various circumstances of the backup-aided computer 11. Therefore, it is required to determine the bandwidth for satisfying such restriction. Namely, from the viewpoint of the schematic expression, it is necessary to conduct the scheduling within the two-dimensional plane of T×R by plotting the time zone T enabling the backup on the horizontal axis and the allowable bandwidth R for data transfer on the vertical axis.

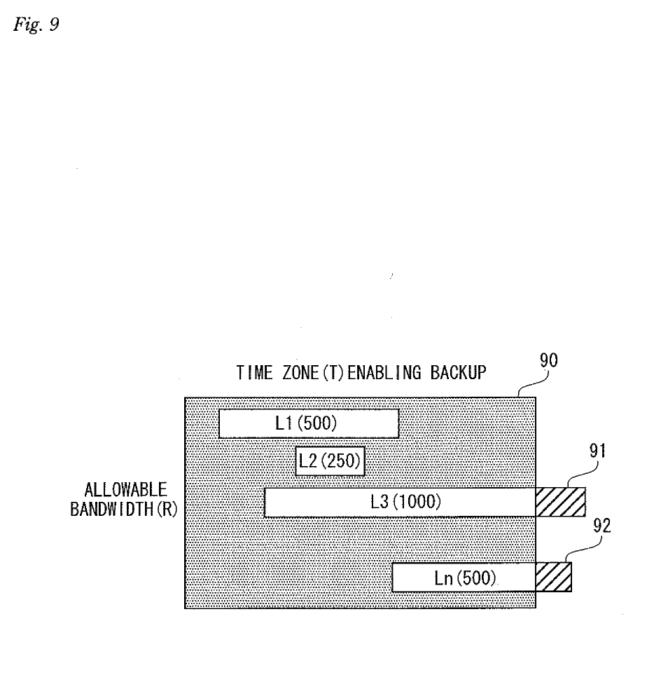

FIG. 9 is a diagram showing a relationship between the time T enabling the backup and the allowable bandwidth R in regard to a transfer rate of the data 10 to be backup-processed.

In FIG. 9, the allowable bandwidth 90 of traffic in WAN 12 is set when the data 10 stored in the backup-aided computer 11 is transferred to the backup apparatus 13 via WAN 12. Values in the parentheses indicate the forecasted transfer rate of the data 10. For the backup-aided computers L3 (1000) and Ln (500), the forecasted transfer rate of the data to be backup-processed exceeds the allowable bandwidth 90 of T×R. Namely, the hatched area 91 of the backup-aided computer L3 (1000) and the hatched area 92 of the backup-aided computer Ln (500) in the figure are exceeding the time T enabling the backup. In this case, the schedule adjusting program 28 is requested to adjust the forecasted transfer rate so that it is accommodated within the time zone T enabling the backup by increasing the allowable bandwidth R in the Y axis direction of the backup-aided computers L3 and Ln. The schedule adjusting program 28 raises the allowable bandwidth in the Y axis direction of the backup-aided computers L3 and Ln. Simultaneously, all backup-aided computers 11 are controlled to follow the restriction on the allowable bandwidth R in the Y axis direction. Therefore, the schedule adjusting program 28 is sometimes requested to reduce bandwidth in the Y axis direction of the backup-aided computer L1 or L2.

A method with which the schedule adjusting program 28 generates a schedule of the backup process by editing the transfer rate will be explained below.

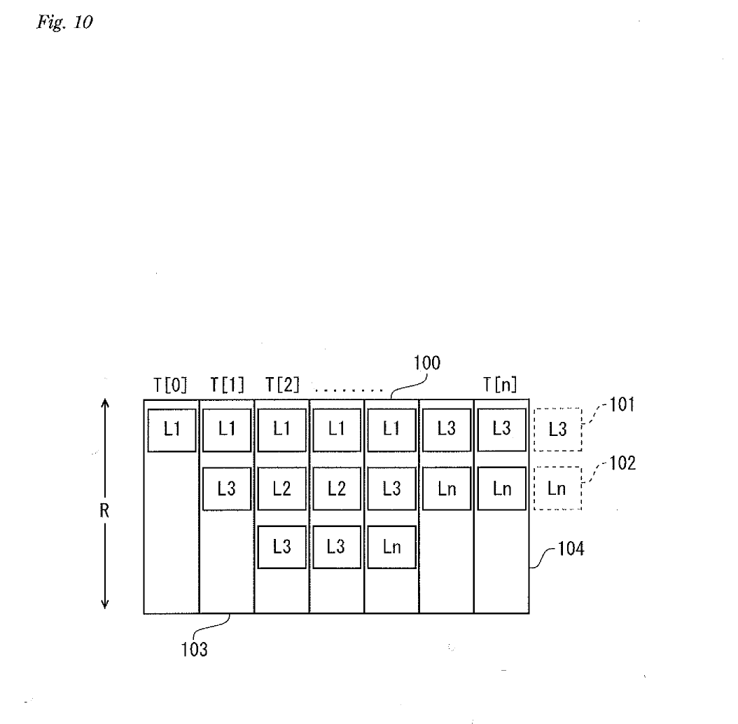

FIG. 10 shows a determination diagram for compliance with restriction in the schedule. This diagram is intended to explain the method with which the forecasted transfer rate of each backup-aided computer 11 satisfies the restriction of T×R between the time zone T enabling the backup and the allowable bandwidth R for transferring the data 10.

First, the schedule adjusting program stored in the hard disk drive 24 of the backup apparatus 13 divides the transfer rate of the data 10 to be backup-processed with a constant time (for example, 10 minutes). The transfer rate obtained by dividing such transfer rate with this constant time is defined as one control unit and is then shown in the figure as a block. The schedule adjusting program 40 generates a schedule in the manner that the blocks domain-divided in one control unit are accommodated within the range 100 of the allowable bandwidth of T×R. In the figure, if such blocks are not accommodated in the X axis direction 103, violation of restriction for the allowable bandwidth R is determined and if the blocks are not accommodated in the Y axis direction 104, violation of restriction for the time T enabling the backup is determined. Accordingly, the schedule adjusting program 28 pays attention to the backup-aided computers L3 (101) and Ln (102) having generated violation of restriction in the forecasted transfer rate of the data 10.

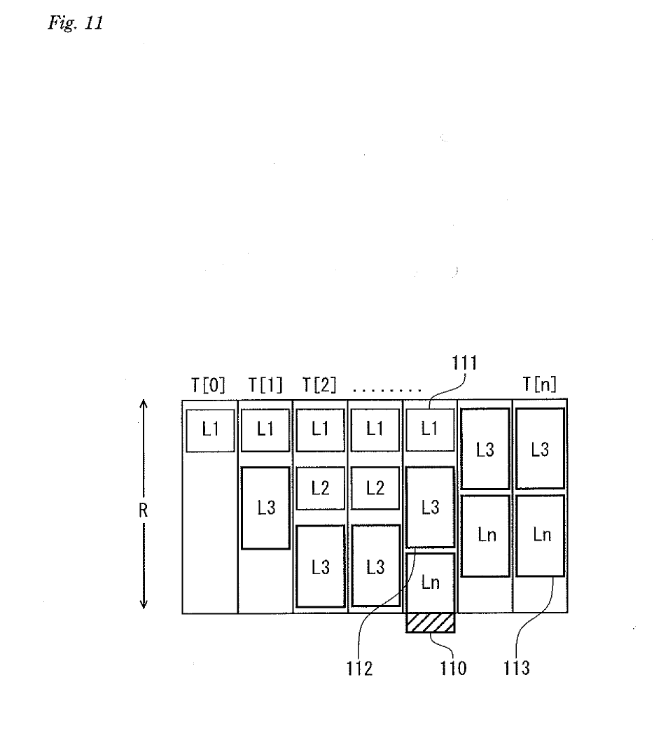

FIG. 11 shows a diagram for explaining a method of adjusting the allowable bandwidth R in the Y axis direction in the relational diagram of the time zone T (T[0] to T[n]) enabling the backup and the allowable bandwidth R for transferring the data 10.

The schedule adjusting program 28 adjusts the blocks in the period in the X direction where violation of restriction in the forecasted transfer rate is generated. In the adjusting method of the blocks, the schedule adjusting program 28 edits the backup-aided computers L3 (112) and Ln (113). Here, the schedule adjusting program 28 increases the forecasted transfer rates of the backup-aided computers L3 (112) and Ln (113). As explained above, the schedule adjusting program 28 restricts the transfer rate of the data 10 to be accepted within the time T enabling the backup.

Here, transfer rate of the data 10 is restricted to be accommodated within the time T enabling the backup. However, as indicated with the hatched area 110 of the backup-aided computer Ln, a part of the blocks of the backup-aided computer Ln is not accepted within the time T and thereby violation of restriction for the allowable bandwidth R in the Y axis direction occurs. Next, an adjusting method when violation of restriction for the allowable bandwidth R in the Y axis direction occurs will be explained below.

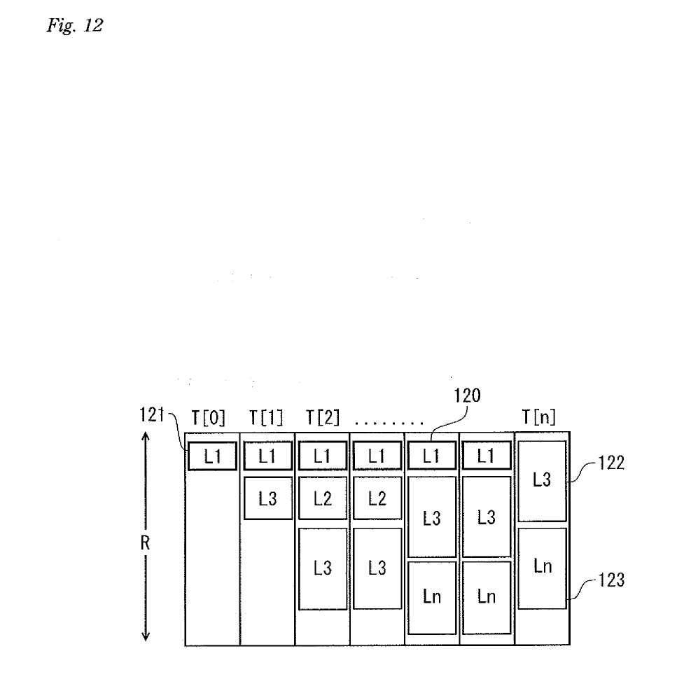

FIG. 12 shows a diagram for explaining the adjusting method when the transfer rate of the data 10 is not accepted within the R direction.

Here, the schedule adjusting program 28 pays attention to the backup-aided computer Ln (113) regarding violation of restriction in the forecasted transfer rage of the data 10 in the allowable band R in the Y axis direction in FIG. 11. The schedule adjusting program 28 conducts edition of the total transfer rate of the backup-aided computers L1 (111), L3 (112), and Ln (113) to set this total transfer rate within the allowable bandwidth R in the Y axis direction. First, the schedule adjusting program 28 determines whether it is possible to reduce the bandwidth of the forecasted transfer rate of any of the backup-aided computers L1 (111), L3 (112) and Ln (113).

FIG. 12 shows a diagram where the schedule adjusting program 28 increases the bandwidth of the forecasted transfer rates of the backup-aided computers L3 (122) and Ln (123) having generated violence of restriction within the time zone T enabling the backup of the X axis. Next, if the schedule adjusting program 28 reduces again the bandwidth of the backup-aided computers L3 (122) and Ln (123), the transfer rates are no longer settled within the time zone T enabling the backup as shown in FIG. 10. That is, it is determined that the transfer rate is not accommodated in the X axis direction and thereby violation of restriction for the time T enabling the backup has occurred.

In such a case, the schedule adjusting program 28 determines the blocks which can be edited within the backup-aided computers L1 (121), L3 (122) and Ln (123) for the adjustment of the allowable bandwidth R in the Y axis direction. As explained above, it is impossible to reduce bandwidth of the forecasted transfer rates of the backup-aided computers L3 (122) and Ln (123).

Therefore, the schedule adjusting program 28 adequately lowers the bandwidth of the forecasted transfer rate of the backup-aided computer L1 (121). Thereafter, the schedule adjusting program 28 determined again that violence of restriction does not occur, because the blocks in the time zone T enabling the backup and the allowable bandwidth R are accepted within the two-dimensional plane 120 of T×R. Thereafter, the schedule adjusting program 28 repeats the processes explained above until violation of restriction in the forecasted transfer rate of the data 10 to be backup-processed disappears.

However, even if violation of restriction in the allowable bandwidth R in the Y axis direction occurs, any of the forecasted transfer rates of the data 10 to be backup-processed in the shape of block cannot be reduced in a certain case in the bandwidth within the backup-aided computers L1 to Ln. In this case, the schedule adjusting program 28 generates again the restriction determination diagram after selection or deletion of the adequate block of the forecasted transfer rate of the data 10 to be backup-processed. Moreover, the schedule adjusting program 28 adjusts the allowable bandwidth R in the Y axis direction. The schedule adjusting program 28 stores the block information as the forecasted transfer rate other than the object of backup process in the hard disk drive 24 in the backup apparatus 13.

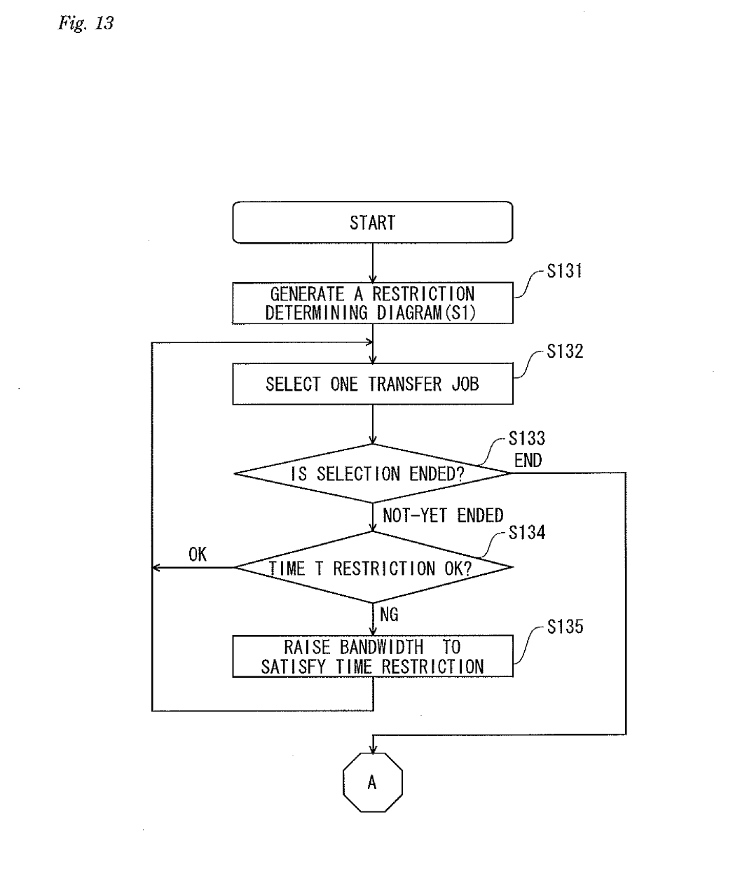

FIG. 13 shows a flowchart of the method of determining compliance with the restriction of the schedule shown in FIG. 9 to FIG. 12. A method of generating or editing the schedule of backup process with the schedule adjusting program 28 will be explained below in detail.

The schedule adjusting program 28 stored in the hard disk drive 24 of the backup apparatus 13 generates a restriction determining diagram showing the relationship between the time zone T enabling the backup and the allowable bandwidth R on the basis of the transfer rate determined with the transfer rate determining program 27 (operation S131).

Here, the data 10 to be backup-processed with the backup apparatus 13 is called a transfer job.

The schedule adjusting program 28 selects a transfer job from the backup-aided computers L1 to Ln (operation S132).

The schedule adjusting program 28 determines whether selection of the transfer job has completed (operation S133).

Here, the schedule adjusting program 28 determines, during selection of the transfer job, whether violence occurs in the restriction of the time T enabling the backup (operation S134). When the schedule adjusting program 28 determines that violence of restriction in the time zone T enabling the backup does not occur in the selected transfer job, the process returns to the operation S132. The schedule adjusting program 28 repeats determination of violence of restriction by selecting the transfer jobs of the other kinds which are not yet determined in occurrence of violent of the restriction.

Moreover, in the operation S134, the schedule adjusting program 28 determines that violent of restriction in the time T enabling the backup is generated in the selected transfer job. In this case, the schedule adjusting program 28 increases bandwidth of the transfer job having generated violence of restriction and conducts adjustment to satisfy the restriction of the time zone T enabling the backup (operation S135). After the adjustment explained above, the operation returns to the operation S132. Here, the schedule adjusting program 28 repeats determination of violence of restriction by selecting the transfer jobs of the other kinds where violence of restriction is not yet determined.

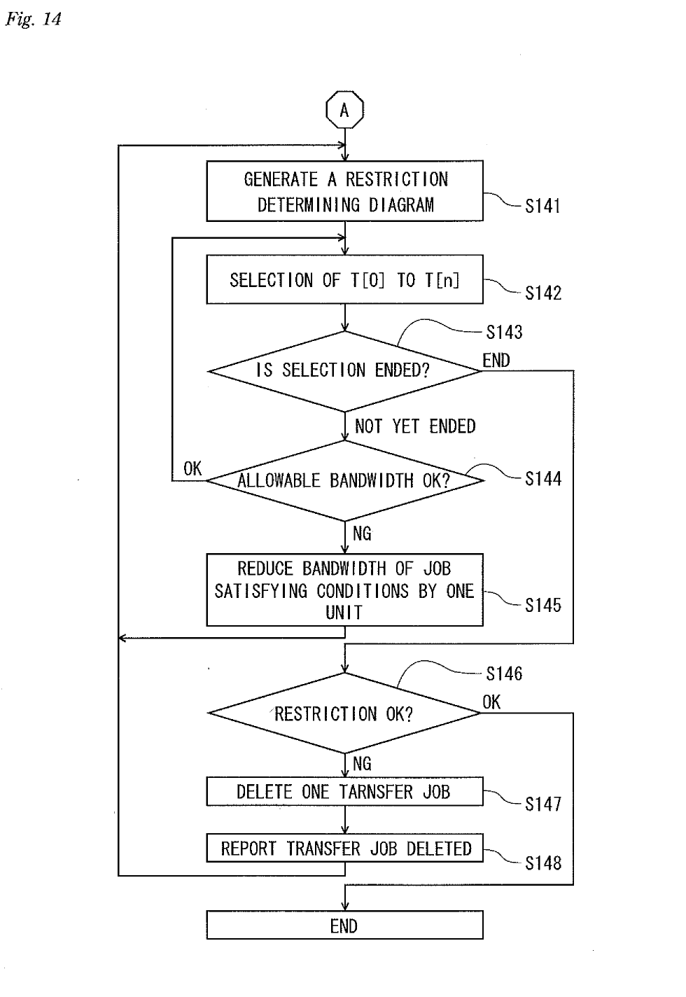

FIG. 14 shows a flowchart of the method of determination of compliance with restriction of the schedule indicated in FIG. 9 to FIG. 12, following FIG. 13.

In the operation S133 explained above, the schedule adjusting program 28 completes selection of the transfer job. In this case, the schedule adjusting program 28 divides the bandwidth indicating the transfer rate of the data to be backup-processed with a constant time (for example, 10 minutes). The transfer rate divided into one control unit is called a block. The schedule adjusting program 28 generates a restriction determination diagram in order to accommodate such block within a rectangular shape (restriction determination diagram) of T×R between the time T enabling the backup in the X axis direction and the allowable bandwidth R for data transfer in the X axis direction (operation S141).

From above explanation, the schedule adjusting program 28 determines that any violation of restriction for the time T enabling the backup in the X axis direction does not occur. Next, this schedule adjusting program 28 determines whether violation of restriction for the allowable bandwidth R in the Y axis direction occurs.

A method of adjustment in the R direction for the relational diagram of the time zone T (T[0] to T[n]) enabling the backup and the allowable bandwidth R in FIG. 12 explained above will be explained below.

Transfer jobs are arranged within the time zone T (T[0] to T[n]) enabling the backup. The schedule adjusting program 28 sequentially selects T[0] to T[n] for determining the transfer job occurring violation of restriction within the allowable bandwidth R in the Y axis direction (operation S142).

Here, the schedule adjusting program 28 repeatedly selects T[0] to T[n] (operation S143).

Moreover, the schedule adjusting program 28 also determines whether a transfer job has occurred violation of restriction in the Y axis direction during the time zone from T[0] to T[n] (operation S144). When the transfer job does not occur any violation of restriction in the R axis direction, selection of T[0] to T[n] is completed in the operation S143.

Moreover, when it is determined that the transfer job has occurred violence of restriction in the Y axis direction in the operation S144, the schedule adjusting program 28 reduces bandwidth of the job satisfying the condition by one unit (for example, 1 Mbps) (operation S145).

Thereafter, it is also determined again whether violation of restriction occurs because the block divided in one control unit is not accommodated within the two-dimensional plane of T×R. Here, the schedule adjusting program 28 repeats the processes explained above until the forecasted transfer rate of the data 10 to be backup-processed is accepted within the allowable bandwidth and violation of restriction disappears.

When selection of T[0] to T[n] is completed in the operation S143, the schedule adjusting program 28 determines whether all transfer jobs occur violation of restriction (operation S146).

When the schedule adjusting program 28 determines that all transfer jobs do not occur any violation of restriction, the processes are completed. Here, the schedule adjusting program 28 sends the schedule adjusted for backup process to the schedule storing program 29. Moreover, the schedule adjusting program 28 determines, in some cases, that violation of restriction occurs as a result of determination for violation of restriction in the transfer jobs in the operation S146. Moreover, the backup adjusting program 28 cannot reduce, in some cases, the bandwidth in any blocks of the backup-aided computers L1 to Ln.

In this case, the schedule adjusting program 28 selects and deletes the adequate blocks of the forecasted transfer rate of the data 10 to be backup-processed operation S147).

Thereafter, the schedule adjusting program 28 stores the forecasted transfer rate information which is no longer considered as an object of backup process to the schedule information table 32 on the hard disk drive 24 in the backup apparatus 13 (operation S149).

Upon completion of storing of above information into the schedule information table 32, the schedule adjusting program 28 returns to the operation S141 to generate again the restriction determining diagram and repeats the processes explained above.

As explained above, the data can be decomposed into the blocks of adequate size and can be edited to effectively determine a transfer rate of job. Therefore, it is possible to provide an effective controller, control system, and control program for processing data transfer within a shorter period of time in comparison with the prior art.

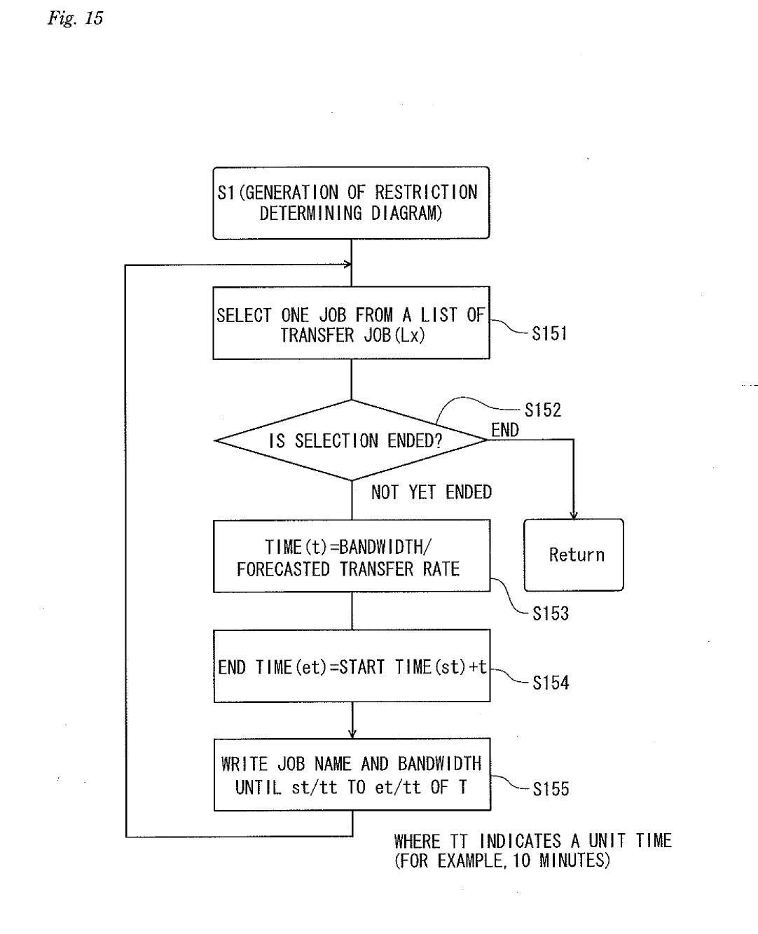

FIG. 15 shows a flowchart showing details in generation of restriction determining diagram in the operation S131 explained with reference to FIG. 13.

In the flowchart of FIG. 15, the schedule adjusting program 28 stored in the hard disk drive 24 of the backup apparatus 13 generates a restriction determining diagram showing the relationship between the time zone T enabling the backup and the allowable bandwidth R on the basis of the transfer rate determined with the transfer rate determining program 27 (operation S200). Here, a transfer rate of the data 10 in the case where the backup apparatus 13 conducts the backup process of the data 10 stored in the backup-aided computers (L1 to Ln) 11 is called a transfer job.

The schedule adjusting program 28 selects a transfer job from a list of the transfer jobs of the backup-aided computers L1 to Ln (operation S151).

The schedule adjusting program 28 determines whether selection of transfer job is completed (operation S151).

Here, it is determined whether violation of restriction in the time zone T enabling the backup has occurred during selection of transfer jobs with the schedule adjusting program 28. For this purpose, a processing time required for the transfer job for the backup process is computed with the method where the bandwidth for backup is divided with the forecasted transfer rate obtained in FIG. 3 to FIG. 7 in view of obtaining a processing time (t) (operation S153).

The time (et) when the backup apparatus 13 completes the backup process is defined as the time obtained by adding the processing time (t) obtained above to the time (st) when the backup process starts (operation S154).

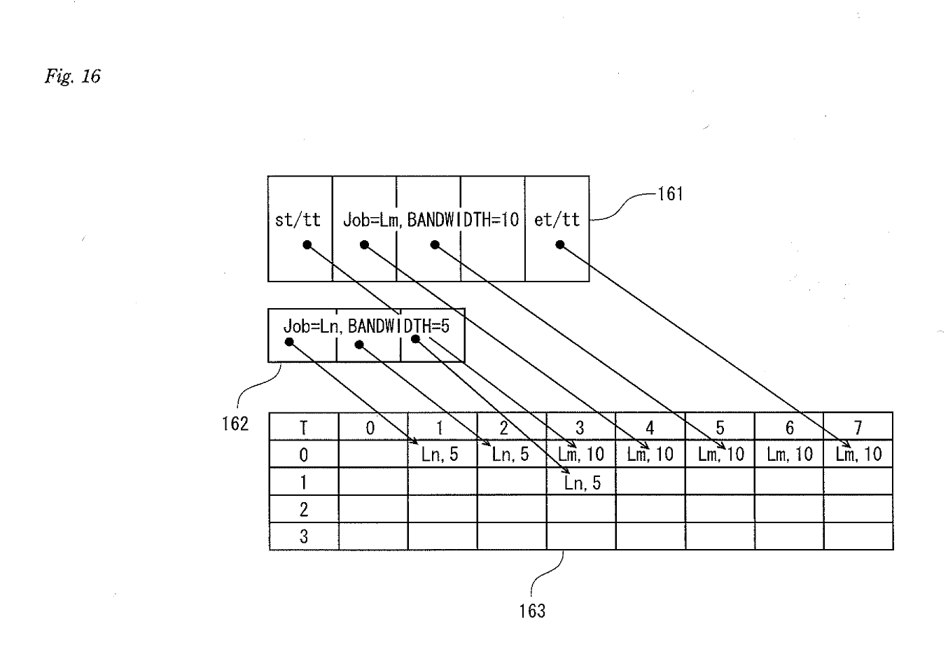

Thereafter, the schedule adjusting program 28 writes, to the data on the memory about the time T in FIG. 16, a kind of job and a bandwidth as the transfer rate until the time (et) for completing the backup process from the time (st) for starting the backup process (operation S155).

Here, tt in the operation S155 indicates a unit time and ten minutes are defined as one unit in this example.

FIG. 16 shows a detail data format diagram referred from the schedule adjusting program 28 in the operation S131 explained for FIG. 13.

In the transfer job 161 of the data 10 in FIG. 16, kind of job is defined as Lm and bandwidth thereof as 10. Moreover, in the transfer job 162 in FIG. 16, kind of job is defined as Ln and bandwidth as 5. A rectangular shape indicates the total transfer rate of respective jobs and the vertical side of the rectangular shape indicates bandwidth and horizontal side thereof indicates time. Moreover, 10 minutes are defined as one unit in graduation in the rectangular shape as explained above.

The data on the memory in FIG. 16 corresponds to a determination diagram for compliance of restriction in FIG. 10 to FIG. 12 explained above. The job Lm of the transfer job 161 in FIG. 16 includes five blocks and the job Ln of the transfer job 162 in FIG. 16 includes three blocks. These blocks are written one by one in the schedule data 163 for backup process on the memory. In the vertical axis of data 163, a total sum of the bandwidths in each job is settled within the allowable bandwidth for data transfer. Moreover, the horizontal axis of schedule data 163 indicates the time zone enabling the backup process. As explained above, the schedule adjusting program 28 is capable of decomposing the data 10 into the blocks of adequate size, editing these blocks and effectively determining a transfer rate of job.

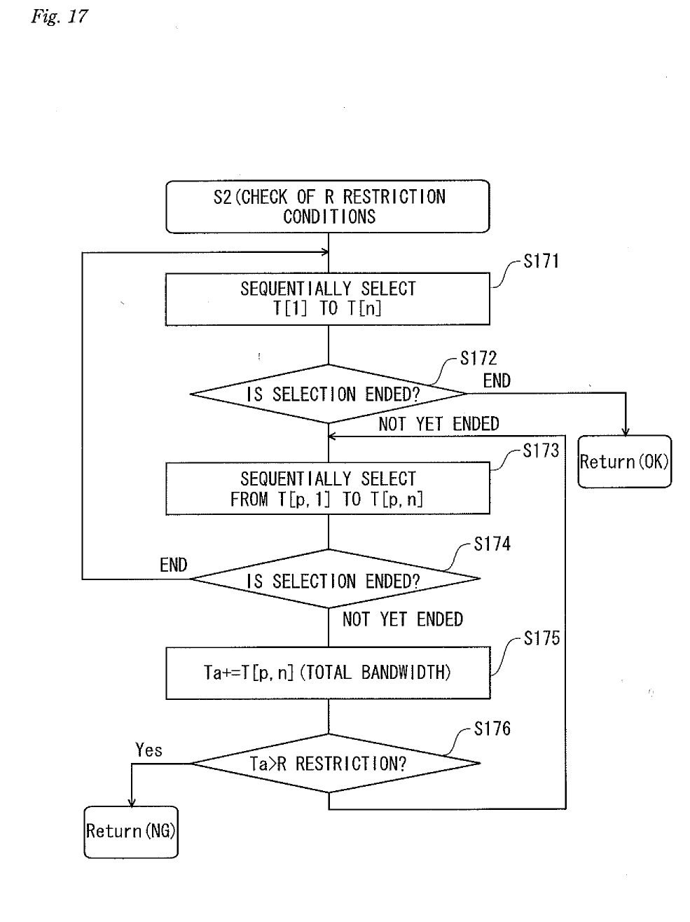

FIG. 17 shows a flowchart showing details of processing operations of the schedule adjusting program 28 in the operation S144 explained with reference to FIG. 14.

The schedule adjusting program 28 further divides a bandwidth indicating a transfer rate of the data 10 to be backup-processed with a constant time (for example, 10 minutes). Here, the schedule adjusting program 28 generates a restriction determining diagram for accommodating the divided blocks within the rectangular shape of T×R (restriction determining diagram) where the horizontal axis indicates the time zone T enabling the backup and the vertical axis indicates the allowable bandwidth R for data transfer. Since it can be determined that any violation of restriction for time zone T in the X axis does not occur from above explanation, whether violation of restriction for allowable bandwidth R in the Y axis direction is generated is then determined.

A detail adjusting method in the direction of bandwidth R in the relational diagram between the time zone T (T[0] to T[n]) and the allowable bandwidth R as explained in FIG. 11 will be explained.

First, the time zone T [T[0] to T[n]] is selected in order to search a transfer job in relation to violation of restriction in the direction bandwidth R arranged in the time zone T (T[0] to T[n]) enabling the backup (operation S171).

The schedule adjusting program 28 repeats selection of T[0] to T[n] to verify the selection (operation S172).

The schedule adjusting program 28 sequentially selects T[p,1] to T[p,n] indicating the bandwidth [0] to [n] at T[p] (operation S173) and repeats the above operations until selection is completed (operation S174).

Next, the schedule adjusting program 28 selects the bandwidth T[0] to T[n] and simultaneously adds the selected bandwidth (operation S175).

Here, the schedule adjusting program 28 obtains a result of addition of T[p,1] to T[p,n] as the total bandwidth Ta of T[p]. Moreover, whether the total bandwidth Ta of T[p] is within the allowable bandwidth R for the backup process is determined (operation S176).

FIG. 18A indicates a detail schedule data for the processing operations of the schedule adjusting program 28 in the operation S144 in FIG. 14 explained above.

FIG. 18B indicates a detail data format diagram for checking the restriction condition in the operation S144 in FIG. 14 explained above. In the data format diagram of FIG. 18B, the schedule information for backup process when the restriction conditions are satisfied is indicated.

Data in FIG. 18A are provided for obtaining the total bandwidth in T[p] in the flowchart explained with reference to FIG. 17. For example, the all bandwidths arranged in the horizontal axis T[p] 181 in the data of FIG. 18A includes the jobs in three kinds of Lm (bandwidth is 10), Ln (bandwidth is 5) and Lp (bandwidth is 30). Therefore, the total bandwidth Ta is 45 as a result of addition of the bandwidths 10, 5, and 30 of the jobs Lm, Ln and Lp. Such total amount of bandwidths is always determined and it is verified whether such total rate is within the allowable bandwidth R enabling the backup process.

Accordingly, the schedule adjusting program 28 can surely determine a transfer rate of job through avoidance of congesting state of bandwidths by editing the data decomposed into the blocks of adequate size and by always determining the total rate of bandwidths.

As the data on the memory shown in FIG. 18B, the information is stored, including the base place names 183 as the backup-aided computers 111, file names 184 of the data 10 to be backup-processed, start time 185 of backup process by the backup apparatus 13, forecasted transfer rate 186 for data transfer from the backup-aided computer 11 by the backup apparatus 13, and bandwidth 187.

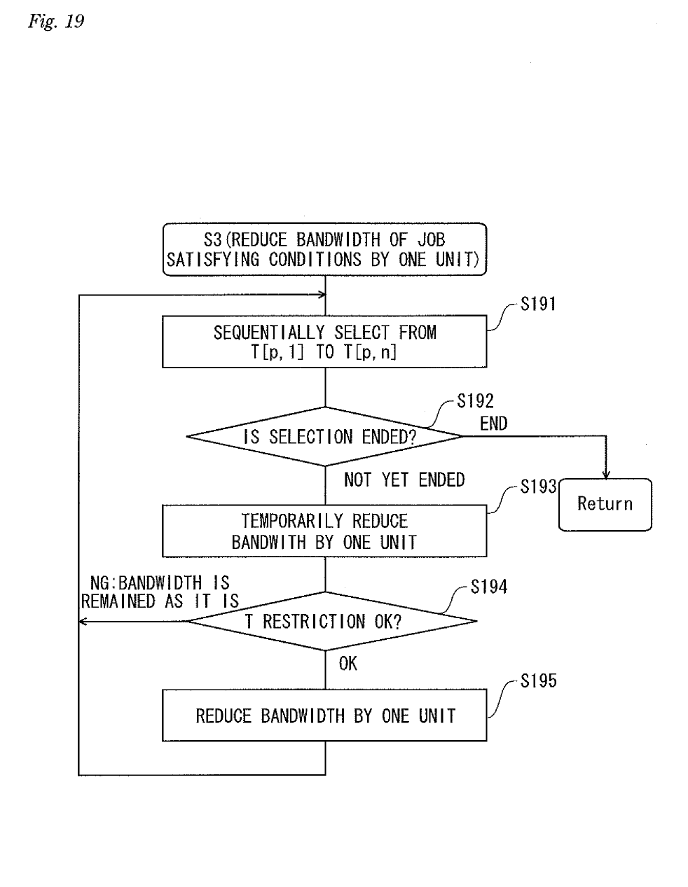

FIG. 19 shows a flowchart of a detail method for reducing bandwidth of jobs satisfying the conditions by one unit in the operation S145 explained with reference to FIG. 14.

Upon determination that violence of restriction in the time zone T in the X axis direction does not occur, the schedule adjusting program 28 determines whether violence of restriction occurs in the bandwidth in the Y axis direction. The schedule adjusting program 28 determines here whether violence of restriction in the Y axis direction in the transfer job within the time T (T[0] to T[n]) as shown in FIG. 12 occurs.

When it is determined that violence of restriction occurs in the transfer job in the Y axis direction, the schedule adjusting program 28 reduces by one unit (for example, 1 Mbps) the bandwidth of job satisfying the conditions. Moreover, the schedule adjusting program 28 sequentially selects T[p,1] to T[p,n] indicating the bandwidth T[0] to T[n] in T[p] (operation S191) and repeats the operations explained above until completion of selection (operation S192).

Here, the schedule adjusting program 28 temporarily reduce by one unit the bandwidth of the selected job on the occasion of sequentially selecting T[p,1] to T[p,n] (operation S193).

Moreover, the schedule adjusting program 28 determines whether time zone T restriction is satisfied when the bandwidth of selected job is temporarily reduced by one unit (operation S194).

When, the time zone T restriction is satisfied, the schedule adjusting program 28 reduced by one unit the bandwidth of selected job (operation s195).

In addition, the time zone T restriction is not satisfied in some cases even when the bandwidth of selected job is temporarily reduced by one unit with the schedule adjusting program 28 in the operation S193. In this case, the bandwidth reduced by one unit is reset to the original state and the process returns to the operation S191 in order to select bandwidth of unselected job from the bandwidth t[0] to T[n] in T[p] and repeats the operation explained above.

As explained above, the schedule adjusting program 28 is capable of effectively determining a transfer rate of job without useless time by decomposing the data into the blocks in the adequate size and then editing the same blocks. Accordingly, the present invention can provide effective controller, control system and control program for processing the data transfer within a shorter period of time in comparison with the prior art.

The backup apparatus 13 in the backup system explained above is capable of always storing the latest information of jobs resulting in the state that the latest information is always stored in the backup apparatus 13. Accordingly, this backup apparatus 13 can provide the stable controller, control system and control program which can immediately recover the latest environment even after occurrence of a disaster.

FIG. 20 shows a flowchart showing the processes executed with the backup processing program 20 stored in the backup apparatus 13.

The backup processing program 30 in the backup apparatus 13 executes the backup processes in accordance with the schedule information explained with reference to FIG. 18B (operation S201).

Here, the backup processing program 30 transmits a transfer request of backup data to the backup-aided computer 11 at the start time stored in the schedule information table 32. The backup-aided computer 11 transmits the data 10 to the backup apparatus 13, upon reception of the transfer request. The backup apparatus 13 receives the data 10 of the backup-aided computer 11 (operation S202).

The backup processing program 30 in the backup apparatus 13 executes the backup process of the data 10 received in accordance with the backup schedule. In addition, the backup processing program 30 stores the data 10 having completed the backup process to the hard disk drive 24 as the backup data 26 (operation S203).

FIG. 21 is a flowchart showing processes executed with the transfer achievement storing program 31 stored in the backup apparatus 13.

The transfer achievement storing program 31 in the backup apparatus 13 obtains a log of the backup process recoded with the backup processing program 30 (operation S221).

The transfer achievement storing program 30 writes the log obtained into a log file and stores this log file as the backup log 25 in the hard disk drive 24 of the backup apparatus 13. The backup log 25 has been explained with reference to FIG. 6B (operation S212).

As explained above, the present invention can set up the scheduling without any useless time in comparison with the prior art. Accordingly, the present invention can provide the effective controller, control system, and control program for processing the transfer of backup data within a short period of time.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, failing within the scope thereof.

What is claimed is:

1. A control apparatus connected to a plurality of apparatuses through a communication link and controlling execution of data backup from the apparatuses, comprising:
a controller
determining a transfer rate of backup data transmitted from the plurality of the apparatuses through the communication link based upon past achievement of data transfer rate,
generating a backup schedule by editing the transfer rate of the backup data determined with said transfer rate determining, and
backing up the backup data in accordance with the schedule edited and generated by the schedule adjusting.

2. The control apparatus according to claim 1, further comprising:
storing the backup schedule edited and generated with the schedule adjusting.

3. The control apparatus according to claim 1, wherein the transfer rate determining determines a transfer rate of the backup data from an average transfer rate of the backup data during a past constant period.

4. The control apparatus according to claim 1, wherein the transfer rate determining determines a transfer rate of the backup data from a transfer rate varying pattern of the backup data during a past constant period.

5. The control apparatus according to claim 1, wherein the transfer rate determining obtains a transfer rate of the backup data from history information of the backup data having completed the backing up.

6. The control apparatus according to claim 1, wherein the schedule adjusting domain-divides, in a constant time interval, the transfer rate of the backup data included in the schedule and edits the transfer rate based upon a transfer rate of the domain-divided backup data defined as one control unit.

7. The control apparatus according to claim 6, wherein the schedule adjusting edits the transfer rate to accommodate same transfer rate of the backup data within the schedule.

8. The control apparatus according to claim 7, wherein when the backup data domain-divided in the one control unit exists in a domain outside of range of the schedule, the schedule adjusting adjusts bandwidth of the backup data which is same in kind as the backup data domain-divided in the relevant one control unit in the domain outside of range of the schedule and is existing in the domain within the range of the schedule.

9. The control apparatus according to claim 8, wherein when any backup data, domain-divided in one control unit, exists outside of range of the schedule after adjustment of bandwidth of the backup data, the schedule adjusting adjusts the bandwidth of backup data existing within the range of the schedule and permitting adjustment of bandwidth.

10. The control apparatus according to claim 9, wherein the schedule adjusting deletes when an adequate backup data does not exist, a part of the backup data existing within the range of the schedule.

11. The control apparatus according to claim 1, comprising storing a log of an achieved transfer rate for the backing up of the back up data as the past achievement of data transfer rate.

12. The control apparatus according to claim 11, wherein the transfer rate determining determines, after the storing of the achieved transfer rate, a transfer rate of the backup data transmitted through the communication link from a plurality of the apparatuses based upon the past achievement of the data transfer rate of the backup data.

13. A control system, comprising:
a plurality of apparatuses, and
a controller in communication with the plurality of the apparatuses through a communication link and backing up data stored in the apparatuses
wherein the controller
determining a transfer rate of the data transmitted from the plurality of said apparatuses through the communication link based upon past achieved data transfer rate during past backing up of the data,
generating and adjusting a backup schedule based upon the determined data transfer rate of the data, and
backing up the data in accordance with information stored in the adjusted backup schedule.

14. The control system of claim 13, wherein the determining of the transfer rate of the data is based upon an average transfer rate of the data during a past constant backup period of time, a variation pattern of past transfer rates of the data during a past constant backup period of time, history information of the data, or any combinations thereof.

15. The control system according to claim 14, wherein the schedule adjusting comprises:
domain dividing, in a constant time interval, the transfer rate of the backup data included in the backup schedule, and
editing the transfer rate based upon a transfer rate of the domain-divided backup data defined as one control unit and/or editing the transfer rate to accommodate same transfer rate of the backup data within the schedule.

16. The control system according to claim 15, wherein when the backup data domain-divided in the one control unit exists in a domain outside of range of the schedule, the schedule adjusting adjusts bandwidth of the backup data which is same in kind as the backup data domain-divided in a relevant one control unit in the domain outside of range of the schedule and is existing in the domain within the range of the schedule, and/or when any backup data, domain-divided in one control unit, exists outside of range of the schedule after adjustment of bandwidth of the backup data, the schedule adjusting adjusts the bandwidth of backup data existing within the range of the schedule and permitting adjustment of bandwidth.

17. A computer readable medium storing a backup program controlling a computer, connected with a plurality of apparatuses through a communication link, according to operations comprising:
determining as a backup schedule a transfer rate of backup data transmitted from the plurality of the apparatuses through the communication link based upon past achievement of data transfer rate,
adjusting the backup schedule by editing the transfer rate of the backup data determined with said transfer rate determining, and
backing up the backup data in accordance with the edited backup schedule by the schedule adjusting.

18. The computer readable medium of claim 17, wherein the determining of the transfer rate of the backup data as the backup schedule is based upon an average transfer rate of the data during a past constant backup period of time, a variation pattern of past transfer rates of the data during a past constant backup period of time, history information of the data, or any combinations thereof.

19. A method of backing up data by a computer in communication with a plurality of apparatuses storing the data through a communication link, comprising:
determining a transfer rate as a backing up schedule of backup data transmitted from the plurality of said apparatuses through the communication link based upon past achieved data transfer rate during past backing up the data,
adjusting the determined data transfer rate of the backup data in the backing up schedule, and
backing up the backup data in accordance with information stored in the adjusted backing up schedule.

20. The method of claim 19, wherein the computer and/or the plurality of apparatuses determine the backing up schedule.

21. The method of claim 19, wherein the determination of the transfer rate as the backing up schedule is based upon an average transfer rate of the data during a past constant backup period of time, a variation pattern of past transfer rates of the data during a past constant backup period of time, history information of the data, or any combinations thereof.

22. The method according to claim 21, wherein the schedule adjusting comprises domain dividing, in a constant time interval, the transfer rate of the backup data included in the backup schedule and editing the transfer rate based upon a transfer rate of the domain-divided backup data defined as one control unit.

23. The method according to claim 22, wherein the schedule adjusting edits the transfer rate to accommodate same transfer rate of the backup data within the schedule.

24. The method of claim 23, wherein when the backup data domain-divided in the one control unit exists in a domain outside of range of the schedule, the schedule adjusting adjusts bandwidth of the backup data which is same in kind as the backup data domain-divided in a relevant one control unit in the domain outside of range of the schedule and is existing in the domain within the range of the schedule.

25. The method of claim 24, wherein when any backup data, domain-divided in one control unit, exists outside of range of the schedule after adjustment of bandwidth of the backup data, the schedule adjusting adjusts the bandwidth of backup data existing within the range of the schedule and permitting adjustment of bandwidth.
